(19) United States
(12) Patent Application Publication
(10) Pub. No.: US 2025/0306225 A1
(43) Pub. Date: Oct. 2, 2025

(54) HIGHER-ORDER SPECTRAL APPROACH FOR SEISMIC INTERPRETATION

(71) Applicant: Schlumberger Technology Corporation, Sugar Land, TX (US)

(72) Inventor: Hiren Maniar, Houston, TX (US)

(21) Appl. No.: 19/098,564

(22) Filed: Apr. 2, 2025

Related U.S. Application Data
(60) Provisional application No. 63/573,082, filed on Apr. 2, 2024.

(51) Int. Cl. G01V 1/28; G01V 1/30; G01V 1/50

(52) U.S. Cl. CPC G01V 1/282; G01V 1/30; G01V 1/50; G01V 2210/43

(57) ABSTRACT

A method for estimating higher-order dependencies from input data includes receiving input data. The method also includes generating multi-tapered spectral estimates based upon input data. The method also includes determining dependencies based at least partially upon the multi-tapered spectral estimates. The method also includes building or updating a deep learning foundation model to employ the dependencies.

### CROSS-REFERENCE TO RELATED APPLICATIONS

This application claims priority to and benefit of U.S. Provisional Patent Application No. 63/573,082, filed on Apr. 2, 2024, which is incorporated by reference herein in its entirety.

### BACKGROUND

Seismic data can include features that are localized, sparsely occurring, diverse, and/or exhibit nonlinearities (e.g., complex). Some examples in post-stack seismic data include top of salt, faults, structural and stratigraphic traps, and direct carbon indicators (DHI) such as bright spots, dim spots, shadow effects, etc. Pre-stack data along with additional sources of recordings may provide unique attributes reflecting changes in velocity, density, porosity, lithology, thickness, and fluid contents of the rock. In several instances, strong and rapid changes in amplitude (or phase) may be of interest. Often, these features of interest, or their rapid changes, occur infrequently in the data. Some of these features are strongly correlated with the presence of oil, and hence their robust detection is of interest.

Features that are diverse, nonlinear, localized (e.g., in space or time), and/or occur sparsely may be difficult to characterize compactly and robustly. For these reasons, they are difficult to detect in voluminous data. Nonlinearity of features suggests the presence of higher-order correlations within (e.g., beyond second order). If these higher-order correlations can be reliably estimated, such features may be singled out by a comparison to the commonly occurring seismic undulations. Seismic data introduces a further hurdle—nonstationarity. Nonstationarity involves the use of short sample lengths in characterizing quantities. Thus, estimation of higher-order correlations is difficult. Localization, diversity, and sparsity imply that there are simply not enough samples to reliably estimate higher-order correlations.

Generally, when dealing with small sample sizes, and short sequence lengths, working in the frequency domain provides estimators with better statistical properties. For this and other reasons, attempts by the seismic processing and interpretation community to use spectral methods to capture higher-order correlations are not new. To obtain higher correlations, one may consider higher-order spectral (HOS) methods. Some examples of higher-order spectral methods are bispectra, trispectra, etc. Computing quantities such as bispectra, trispectra, and other HO spectra, entails partitioning of the frequency in pairs, triplets, etc. (i.e. high-dimensional frequency groupings). These groupings grow exponentially. Due to exponentially growing bin counts in higher-dimensional frequency space, there isn't sufficient data to reliably estimate the HO. Therefore, what is needed is an improved higher-order spectral approach for seismic interpretation.

### SUMMARY

A method for estimating higher-order dependencies from input data is disclosed. The method includes receiving input data. The method also includes generating multi-tapered spectral estimates based upon input data. The method also includes determining dependencies based at least partially upon the multi-tapered spectral estimates. The method also includes building or updating a deep learning foundation model to employ the dependencies.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data includes seismic data and well log data. The operations also include transforming the input data into a frequency domain to produce transformed data. The transformed data includes transformed seismic data and transformed well log data. The operations also include generating multi-tapered spectral estimates based upon transformed data. The multi-tapered spectral estimates are based upon the transformed seismic data. The operations also include generating dynamic spectra by applying the first multi-tapered spectral estimates using a first sliding window. The operations also include treating the dynamic spectra as a multi-variate sequence in time or depth to produce treated dynamic spectra. The operations also include transforming the treated dynamic spectra to produce transformed dynamic spectra. The treated dynamic spectra are transformed using a log transform and/or a Fourier transform. The transforming emphasizes higher-order dependencies in the treated dynamic spectra. The operations also include determining derivatives of the transformed dynamic spectra. The operations also include determining dependencies based upon the treated dynamic spectra and/or the derivatives. The dependencies are used directly to analyze spectral constructs in the input data. The operations also include building or updating a deep learning foundation model to employ the dependencies. The deep learning foundation model is built or updated based upon the spectral constructs.

A non-transitory computer-readable medium is also disclosed. The medium stores instructions that, when executed by one or more processors of a computing system, cause the computing system to perform operations. The operations include receiving input data. The input data includes seismic data and well log data. The seismic data is captured from a gather space, a pre-stack space, or a post-stack space. The operations also include transforming the input data into a frequency domain to produce transformed data. The transformed data includes transformed seismic data and transformed well log data. Transforming the input data includes tapering the seismic data using a multi-taper spectral approach to produce tapered data. The multi-taper spectral approach employs a plurality of discrete prolate spheroidal sequences as tapers. Transforming the input data also includes transforming the tapered data using a Fourier transform to produce the transformed data. The transformed data is also produced from the input data using a first sliding window. The operations also include generating first multi-tapered spectral estimates based upon transformed data. The first multi-tapered spectral estimates are based upon the transformed seismic data. The first multi-tapered spectral estimates are generated based upon a magnitude square of the transformed seismic data and averaged over the tapered data. The first multi-tapered spectral estimates include power spectra and cross-spectra. The operations also include generating first dynamic spectra by applying the first multi-tapered spectral estimates using a second sliding window. The second sliding window is conducted in time, depth, or spatially. The first dynamic spectra include first spectrograms. The operations also include treating the first dynamic spectra as a first multi-variate sequence in time or depth to produce first treated dynamic spectra. Treating the first dynamic spectra includes log transforming the first dynamic spectra to produce first log transformed dynamic spectra, and/or differencing the first log transformed dynamic spectra with local averages thereof to produce the first treated dynamic spectra. The operations also include generating second multi-tapered spectral estimates based upon the input data. The second multi-tapered spectral estimates are based upon the transformed data. Different types of the transformed data provide different second multi-tapered spectral estimates. Pairs of the second multi-tapered spectral estimates are combined to produce first cross-spectra. Pairs of the first multi-tapered spectral estimates and the second multi-tapered spectral estimate are combined to produce second cross-spectra. The second multi-tapered spectral estimates are employed in a depth-wise piecemeal fashion. The operations also include generating second dynamic spectra based upon the second multi-tapered spectral estimates. The second dynamic spectra are generated by applying the second multi-tapered spectral estimates using a third sliding window. The third sliding window is conducted in depth. The second dynamic spectra include second spectrograms. The second spectrograms include log-log cross-spectrograms and/or log-seismic cross-spectrograms. The operations also include treating the second dynamic spectra as a second multi-variate sequence in time or depth to produce second treated dynamic spectra. Treating the second dynamic spectra includes log transforming the second dynamic spectra to produce second log transformed dynamic spectra, and/or differencing the second log transformed dynamic spectra with local averages thereof to produce the second treated dynamic spectra. The first and/or second dynamic spectra are employed to detect geo-features. The geo-features include salt bodies and/or a top of salt. The operations also include transforming the first and second treated dynamic spectra to produce transformed dynamic spectra. The first and second treated dynamic spectra are transformed using a log transform and a Fourier transform. Transforming emphasizes higher-order dependencies in the first and/or second treated dynamic spectra. The operations also include determining derivatives of the transformed dynamic spectra. The derivatives are determined based upon time, depth, and/or frequency. The derivatives are performed directionally. The operations also include determining dependencies based upon the first and second treated dynamic spectra and the derivatives. The dependencies are between different frequencies, depth, and/or time. The dependencies include spectral dependencies, instantaneous spectral dependencies, cepstral summaries, cross-coherence, and/or quantities derived therefrom. The dependencies are used directly to analyze spectral constructs in the input data. The spectral constructs are employed to modify or replace attention mechanisms in transformer architectures. The spectral constructs provide better estimator or statistical properties when dealing with sample sizes less than a predetermined threshold. By repeated and/or sequential processing, the spectral constructs emphasize the higher-order dependencies implicit in the input data. The operations also include building or updating a deep learning foundation model to employ the dependencies. The deep learning foundation model is built or updated based upon the spectral constructs. The deep learning foundation model is built or updated using self-learning methodologies. The deep learning foundation model is also configured to perform downstream seismic and log analysis tasks. The operations also include identifying features in the input data using the deep learning foundation model. The spectral constructs steer the deep learning foundation model to indirectly identify the features emphasizing higher-order statistical moments within the input data. The spectral constructs control a nature of the features. The features identified by the deep learning foundation model emphasize higher-order dependencies in the input data due to an influence of the spectral constructs. The features include seismic features. The seismic features emphasize top of salt, faults, structural and stratigraphic traps, and/or direct carbon indicators. The direct carbon indicators comprise bright spots, flat spots, dim spots, and/or shadow effects.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a schematic view of a vision-type neural network for conducting a seismic analysis, according to an embodiment.

FIG. 3 illustrates a schematic view of a multi-head self-attention (MHSA) module with optional modifications thereto, according to an embodiment.

FIG. 4 illustrates a flowchart of a portion of the MHSA module (e.g., Method D), according to embodiment.

FIGS. 5A-5J illustrate a plurality of images of features generated by the MHS A module (e.g., Method A), according to embodiment.

FIGS. 6A-6H illustrate a plurality of images of features generated by the MHSA module (e.g., Method D), according to embodiment.

FIGS. 7A-7H illustrate a plurality of images of features generated by the MHSA module (e.g., Method B), according to embodiment.

FIG. 8 illustrates a flowchart of a method for generating reliable and robust higher-order correlations from seismic data, according to an embodiment.

FIG. 9 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

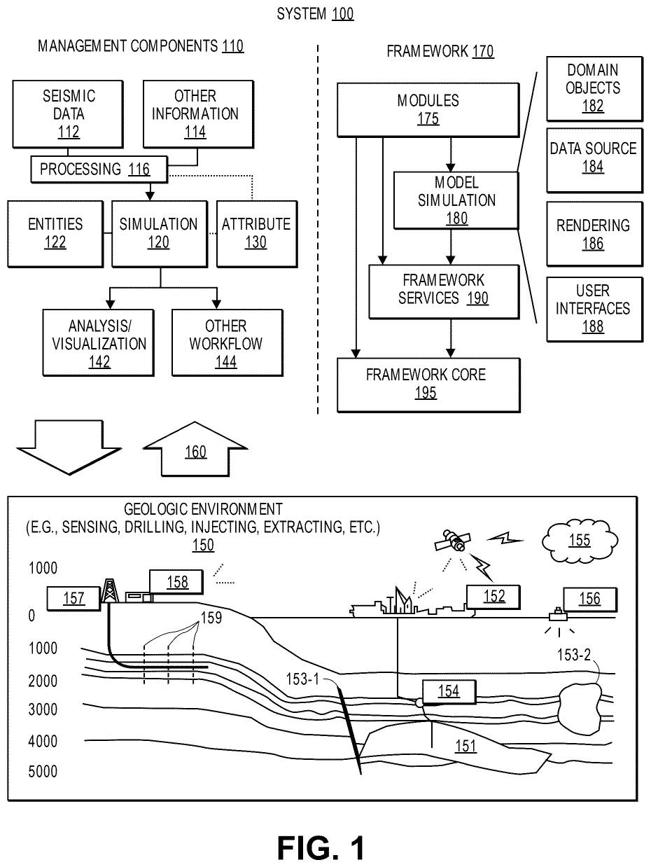

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages.NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Higher-Order Spectral Approach for Seismic Interpretation

There are additional reasons why historical attempts to work in the frequency domain to discover spectral-based quantities may not have fully materialized. Seismic data is inherently nonstationary (e.g., in space or time) and involves applying spectral techniques (e.g., Fourier transforms etc.) over short sample lengths. If these short data segments are not tapered, spectral estimates can be severely biased due to spectral leakage (i.e., narrowband and broadband bias due to mixing of energy from different frequency bands). While the signal processing community has used a variety of taper types to address this issue, the use of single versus multiple tapers has not been fully appreciated. Use of single tapers can address the bias problem, but not the variance problem. Variance reduction can be sought by averaging; however, for nonstationary data or sparsely occurring features, obtaining multiple independent samples to average over is difficult. Use of multiple tapers addresses the variance problem. The specific choice of multiple tapers and its impact on bias-variance trade-off is not fully appreciated. Such methodological considerations can have an impact on spectral estimates, and in turn, the ability to characterize the seismic quantities of interest in the frequency domain.

The hurdles encountered in estimating higher-order correlations are described above. In practice, one must deal with infrequently occurring features (e.g., small sample size), short sample lengths (e.g., working in frequency domain for better estimation properties), complex features (e.g., higher-order correlations), and finally, subtleties of analysis in the frequency domain (e.g., curtailing spectral leakage). Thus, direct estimation of higher-order correlations calculated in the time-domain (e.g., pre-stack, CDP, etc.) and depth-domain (e.g., post-stack) is simply impractical and unreliable. An approach which provides a route out of this dilemma is to treat a spectrogram as a multivariate sequence (e.g., frequency, time/depth) and seek correlations between spectral powers at different frequencies. One observation is that second-order correlations in spectrograms correspond to non-trivial higher-order correlations in the time-/depth-domain. Thus, deriving measures using spectrograms (e.g., dynamic spectra), the method described herein may capture the higher-order correlations in the original domain.

The present disclosure pertains to the use of spectral methods to robustly and reliably estimate higher-order correlations to assist in characterization of unique features in the seismic data. These estimates may assist in seismic interpretation tasks. As a result, they may be employed for direct hydrocarbon identification (DHI).

Some differentiators in the approach described herein are:
(a) to use multi-taper spectral approach to provide reliable and robust means for estimations in the frequency domain;
(b) to use dynamic spectra (e.g., spectrograms) as the starting point, and treat them as a multivariate sequence, and with additional transformations, obtain measures which capture correlations between spectral power at different frequencies (e.g., indirectly providing estimates of higher-order correlations);
(c) to use frequency and/or time (e.g., depth) derivatives of the dynamic spectra as a starting point and treat it as a multivariate sequence (similar to (b));
(d) to use the 2D Fourier transform of the log of the dynamic spectra (e.g., 2D cepstrum); and
(e) to use related data modalities (e.g., rock properties) to use cross-spectrograms as the starting point and treat it as a complex multivariate sequence.

The method employs discrete prolate spheroidal sequences (DPSS; Slepian sequences) as tapers for multi-tapering to balance the narrowband/broadband bias/variance. This multi-taper approach provides reliable and robust spectral estimates. The cepstral representation from the dynamic spectra provides an effective means to compress broad spectrogram features and provides other means to capture correlations. Working with the derivatives of the dynamic spectra can provide an opportunity to emphasize rapid amplitude changes in time/depth or in frequency.

Some examples of measures which can be derived from (b) and (c) are spectral correlations, instantaneous spectral correlations, cepstral summaries, etc. Similarly, other correlative measures may be derived using derivatives of the dynamic spectra as the starting point. This methodology, and variations on the theme, can be used to provide different kinds of spectral measures. Based on the specific seismic feature being targeted, one or more of these spectral measures may be the best means of characterization. For example, certain cepstral summaries of the data can accurately detect top of salt.

Additional transformations, mappings, and other mathematical techniques (e.g., clustering, dimensional reduction methods such as SVD, etc.) may be applied to summarize the spectrally derived quantities. These quantities and their changes in time/depth and frequency may be employed to highlight and identify seismic features. Use of derivatives with respect to frequency as well as time/space may be employed to explicitly accentuate feature attributes (e.g., change in frequency content due to presence of fluid, or rapid changes in amplitude or phase due to reflection).

Finally, the methodology may also be employed to quickly identify specific aspects of seismic data, effectively providing an unsupervised means of generating labels to be used for supervised or semi-supervised machine learning development. ML models trained in such a fashion, and generalized sufficiently, can be applied to other seismic surveys.

### Vision-Type Neural Network

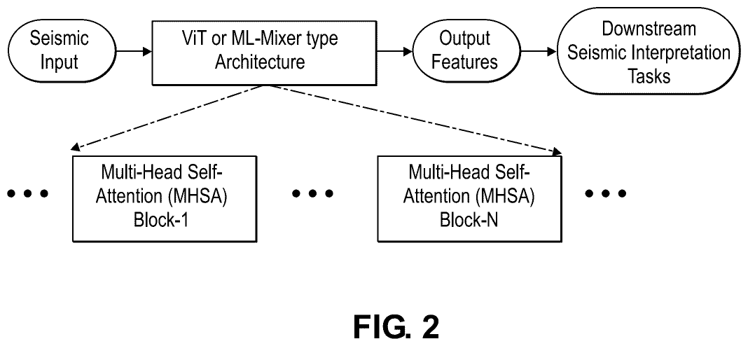

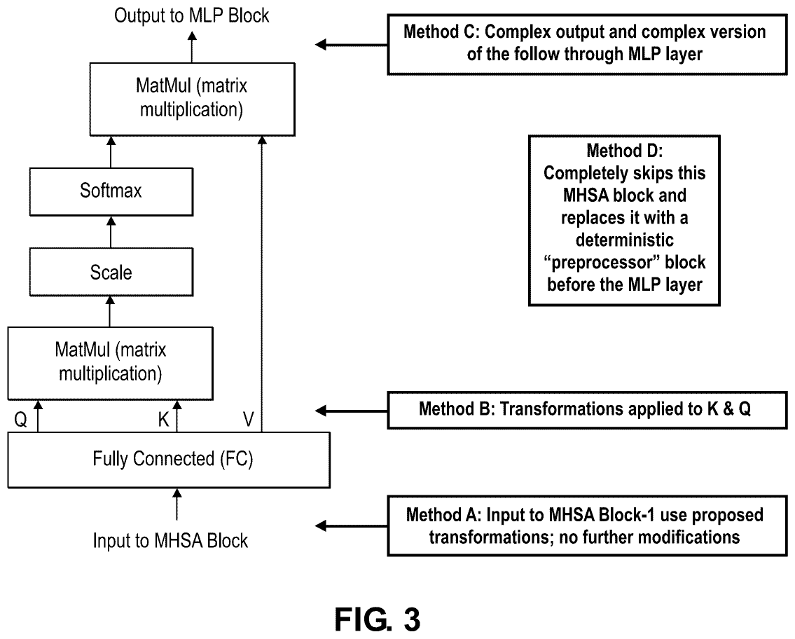

FIG. 2 illustrates a schematic view of a vision-type neural network for conducting a seismic analysis, according to an embodiment. Numerous neural network architectures, including Vision transformers (ViT) or ML-mixer type models, may be employed for seismic feature extraction. The ViT may include numerous blocks of multi-head self-attention (MHSA) computations, for example, in a sequential manner (see FIG. 3). Various self-learning paradigms may be employed during training.

### Multi-Head Self-Attention Module

FIG. 3 illustrates a schematic view of a multi-head self-attention (MHSA) module with optional modifications thereto, according to an embodiment. This particular example focuses on a scaled dot product approach for computing “attention”. However, numerous variations on this theme may be possible. The variables Q, K, V represent query, key, and value, respectively (i.e., intermediate computations). The various methods (i.e., methods A-D) are standalone in scope. The term “transformation” may be understood to mean various steps conducted in the frequency domain.

Higher-order (HO) dependencies (e.g., second-order and higher) in seismic analysis may be more reliably and/or robustly estimated using multi-taper (MT) spectral methodologies. Numerous spectral-based quantities may be determined in the frequency domain, such as spectra, dynamic spectra, cross-spectra, coherence, cepstra, etc. They may then be used in a nested computation to estimate HO dependencies in the seismic data. Such computations are conducted in the frequency domain. These quantities, and methodologies, may be employed in two ways: (a) direct analysis of seismic data, and/or (b) as computational modules within neural networks (and machine-learning in general). When employed within neural networks (NN), one end goal is to obtain a rich and diverse set of seismic features to accomplish numerous seismic interpretation tasks.

The input data to a neural network or data intermediate to neural-network computation may be fast Fourier transformed (FFT) after using multiple tapers (e.g., Slepian sequences) to compute spectral quantities for further processing by the network. In addition, spectral-based modules may be developed to compute one or more frequency domain measures such as: spectra, dynamic spectra, cross-spectra, coherence, and/or cepstra. Various neural network architectures may incorporate such spectral modules as a deterministic or trainable preprocessor for input to trainable NN modules such as attention heads (e.g., a component of MHSA), initial staging of data to a NN, and/or as repeated or selective insertion into NN modules such as the MHSA or NN modules employing attention. The projection of data onto the frequency space and the ensuing spectral computations results in the neural networks shaping the feature space in a distinctively different manner based on second and higher-order dependencies.

Computations involving repeated sequential (i.e., “nested”) use of these spectral quantities in NN reliably and robustly emphasize HO dependencies in the data and thereby enrich the feature/latent space of the NN. Direct attempts to discern such HO dependencies in the original input space of the seismic data may fail because the capture of short-to mid-scale data nuances may depend upon small sample sizes.

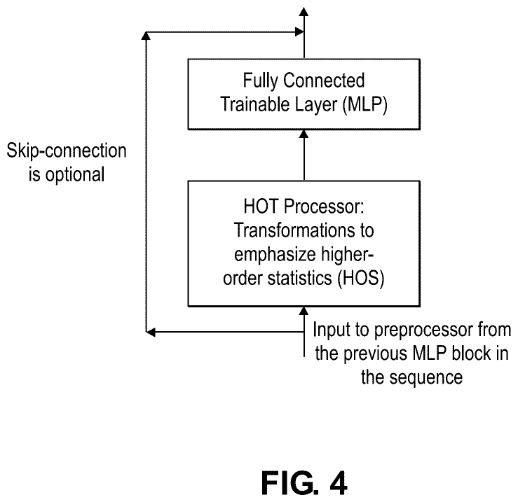

As an example of modify an attention-based NN module, FIG. 4 illustrates a flowchart of a portion of the MHSA module (e.g., Method D), according to embodiment. The spectral calculations may be nested to provide emphasis on higher-order statistical dependencies (e.g., in the frequency domain). The term “transformation” should be understood to mean that the various frequency domain steps are employed. For convenience, the preprocessor is referred to as “HOT” to suggest transformations which induce/emphasize higher-order (HO) statistics. In one version of this implementation, the preprocessor may be deterministic in the sense that it is prescriptive and uses no trainable parameters. However, the follow-through MLP block and sequential repetition of such unit pairing constitutes a deep learning approach. In another version of this implementation, complex versions of the fully connected (FC) module can be devised and employed to ensure phase-integrity while mixing the features amongst themselves as well as spatially or temporally.

### Method A

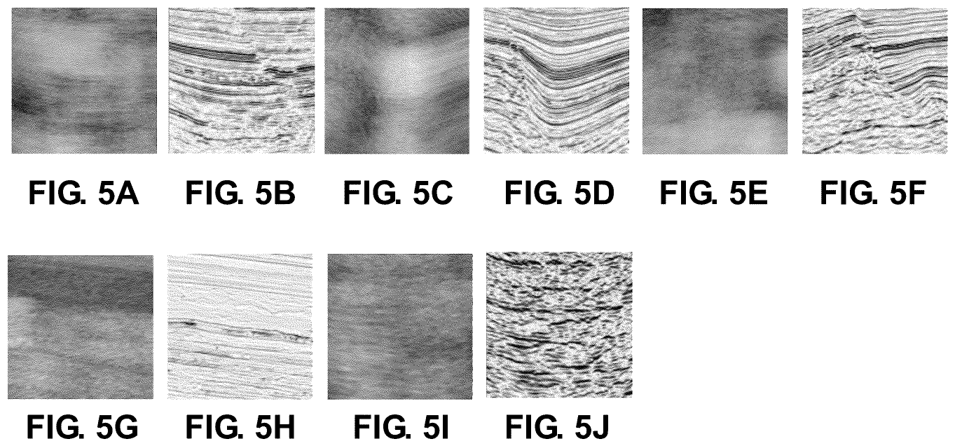

FIGS. 5A-5J illustrate a plurality of images of features generated by the MHSA module (e.g., Method A), according to embodiment. The features and original seismic sections are paired. Every second image (e.g., FIGS. 5B, 5D, 5F, 5H, and 5J) is the original seismic section, and the image to the left of the seismic image (e.g., FIGS. 5A, 5C, 5E, 5G, and 5I) depict the corresponding features extracted by the deep learning methodology (e.g., in this case, Method A). The feature depiction is approximate in the sense that the latent space provides an order of 100's of features, and feature images are the first three dominant components mapped to RGB space for visualization purposes. Qualitatively, correlations between features and the original seismic is evident; however, it is also evident that finer discriminatory criteria lie within the feature vectors as exhibited by the more uniform RGB coloring across “similar” zones and different coloring for different zones.

Spectral computations may be a preprocessing step. They may be directly fed into a neural network during self-learning (e.g. using a DINO approach). The spectral computation may involve a log transform of the power spectrum followed by another round of FFT. The trained network may provide a feature set accentuating and capable of discriminating second- and HO-statistics. FIGS. 5A-5J show visual depictions of such an approach where some features found in seismic snippets may be seen. The feature space is high-dimensional, and the features shown are a low-dimensional approximation. The ability of the approach to discriminate subtle seismic nuances via colors is evident. A network with VIT type architecture was employed.

### Method D

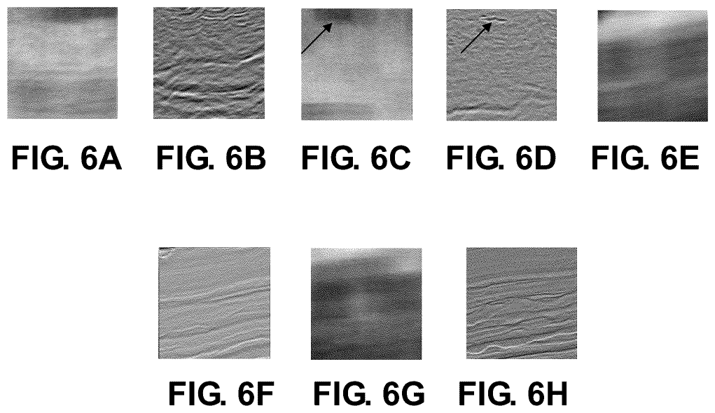

FIGS. 6A-6H illustrate a plurality of images of features generated by the MHSA module (e.g., Method D), according to embodiment. Such features capture the high-order dependencies in seismic data. The features (e.g., FIGS. 6A, 6C, 6E, and 6G) and original seismic sections (e.g., FIGS. 6B, 6D, 6F, and 6H) are paired. Every second image (e.g., FIGS. 6B, 6D, 6F, and 6H) is the original seismic section (in gray scale) and the images to the left (e.g., FIGS. 6A, 6C, 6E, and 6G) depict the corresponding features extracted by the deep learning methodology (e.g., in this case Method-D). The feature depiction is approximate in the sense that the latent space provides an order of 100's of features, and feature images above are the first three dominant components of these mapped to RGB space for visualization purposes. Qualitatively, correlation between features and the original seismic is evident; however, it is also evident that finer discriminatory criteria lie within the feature vectors as exhibited by the more uniform RGB coloring across “similar” zones and different coloring for different zones.

A difference between VIT and MLP-mixer architectures is the absence of the MHSA module. The spectral module may be employed as a preprocessor for each MLP block in an MLP-mixer-like architecture. For the case where the MLP layer accepts real numbers, the spectral module may convert the complex calculations using the absolute operation or stack the real/imaginary vectors. Depending on the depth of the network, this results in nested computations, and the features generated reliably and robustly capture the HO dependencies in the data. FIGS. 6A-6H represent a visual depiction of such an approach where some features found in seismic snippets are shown by the arrows. The feature space is high-dimensional, and the features shown are a low-dimensional approximation. The ability of the approach to segment seismic nuances (e.g., via colors) is evident. A network with MLP-Mixer type architecture was employed.

### Method B

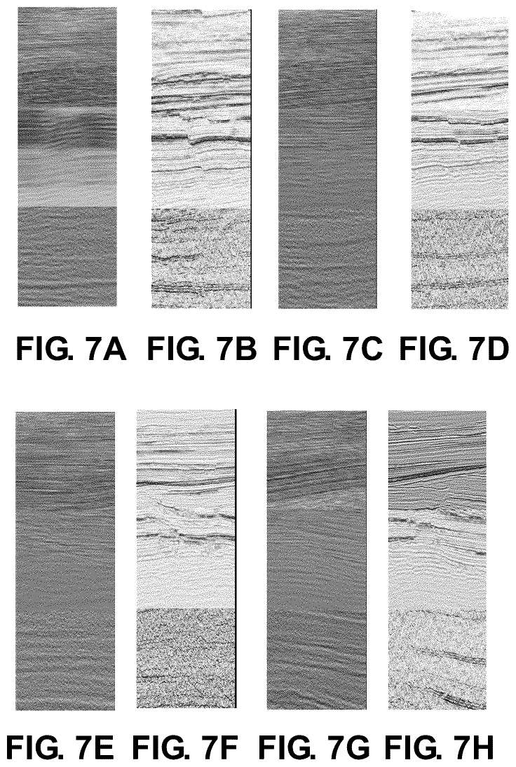

FIGS. 7A-7H illustrate a plurality of images of features generated by the MHSA module (e.g., Method B), according to embodiment. The attention mechanism may be structured to capture the (e.g., hidden) modulations in amplitude and/or frequencies. The features (e.g., FIGS. 7A, 7C, 7E, and 7G) and original seismic sections FIGS. 7B, 7D, 7F, and 7H) are paired. Every second image FIGS. 7B, 7D, 7F, and 7H) is the original seismic section, and the images to the left of the seismic images FIGS. 7A, 7C, 7E, and 7G) show the corresponding features extracted by the deep learning methodology (e.g., in this case Method-B). The feature depiction is approximate in the sense that the latent space provides an order of 100's of features, and feature images above are the first three dominant components of these mapped to RGB space for visualization purposes. The (e.g., color) variations in features is purely an artifact because the feature reduction is conducted locally. For downstream seismic interpretations tasks, more feature vectors may be employed. Qualitatively, dependencies between features and the original seismic is evident; however, it is also evident that finer discriminatory criteria lie within the feature vectors as exhibited by the relatively uniform coloring of “similar” zones.

In Method B, the attention computations of each MHSA may be replaced with a spectral module computing the FFT of the log spectra of the input to the MHSA module. Using the VIT as an example, the query/value (QKV) computations may be modified whereby the Q/K components employ the above-noted spectral approach. The attention computation may be effectively conducted in the frequency space. The spectral module QK computations may result in a complex representation (as in a “complex number”) and both its absolute value or real/imaginary pair may be used to estimate the attention value. This spectral quantity emphasizes the underlying amplitude, frequency, and/or phase modulations in the seismic data. FIGS. 7A-7H represent a visual depiction of such an approach where some features found in seismic snippets are shown. The feature space is high-dimensional, and the features shown are a low-dimensional approximation. The ability of the approach to discriminate subtle seismic nuances (e.g., via colors) is evident. A network with VIT type architecture was employed.

### Method C

A neural network such as the VIT may be reconfigured whereby the MHSA and MLP modules are modified to handle complex numbers. The fully connected (FC) layers in both may be rewritten to deal with a data stream of complex numbers. The spectral modules discussed in Methods A and/or B may be modified to deal with complex numbers.

### Exemplary Method

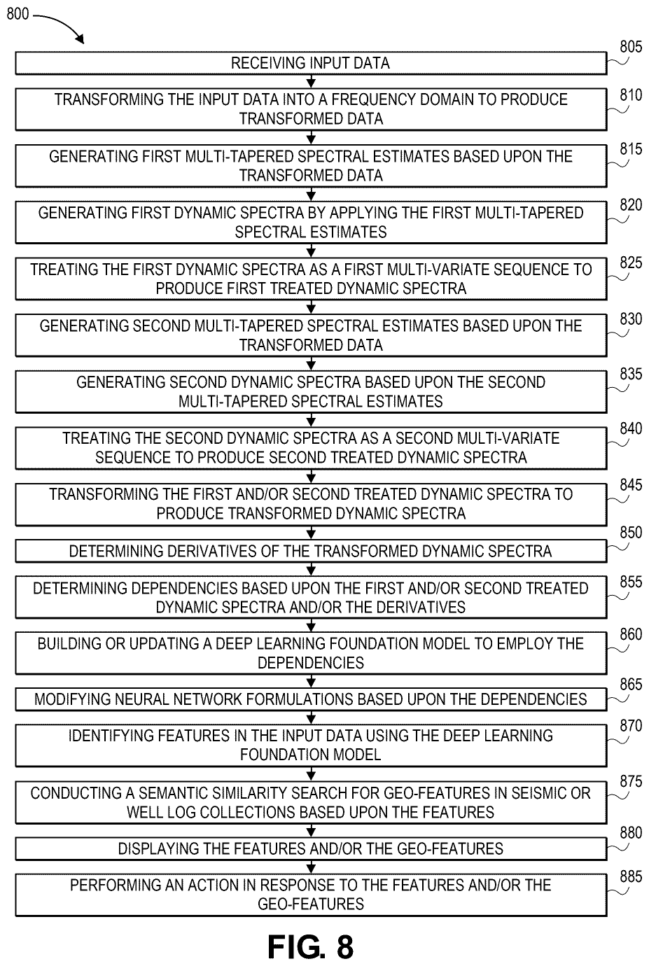

FIG. 8 illustrates a flowchart of a method 800 for estimating higher-order dependencies from (e.g., seismic) data, according to an embodiment. An illustrative order of the method 800 is provided below; however, one or more portions of the method 800 may be performed in a different order, simultaneously, repeated, or omitted. At least a portion of the method 800 may be performed by a computing system.

The method 800 may include receiving input data, as at 805. The input data may include seismic data and/or well log data. The seismic data may be captured from a gather space, a pre-stack space, and/or a post-stack space.

The method 800 may also include transforming the input data into a frequency domain to produce transformed data, as at 810. The transformed data may include transformed seismic data and transformed well log data. Transforming the input data may include tapering the seismic data and/or the well log data using a multi-taper spectral approach to produce tapered data. The multi-taper spectral approach employs a plurality of discrete prolate spheroidal sequences as tapers. Transforming the input data may also or instead include transforming the tapered data using a Fourier transform to produce the transformed data. The transformed data is also produced from the input data using a first sliding window.

The method 800 may also include generating first multi-tapered spectral estimates based upon the input data, as at 815. The first multi-tapered spectral estimates may be based upon the transformed seismic data and/or the transformed well log data. The first multi-tapered spectral estimates may be generated based upon a magnitude square of the transformed seismic data and averaged over the tapered data. The first multi-tapered spectral estimates may include power spectra and/or cross-spectra.

The method 800 may also include generating first dynamic spectra by applying the first multi-tapered spectral estimates (e.g., to the input data) using a second sliding window, as at 820. The second sliding window may be conducted in time, depth, or spatially. The first dynamic spectra may include one or more first spectrograms.

The method 800 may also include treating the first dynamic spectra as a first multi-variate sequence in time or depth to produce first treated dynamic spectra, as at 825. Treating the first dynamic spectra may include log (e.g. mathematical log, not well log) transforming the first dynamic spectra to produce first log transformed dynamic spectra, and/or differencing (e.g., subtracting) the first log transformed dynamic spectra with local averages thereof to produce the first treated dynamic spectra.

The method 800 may also include generating second multi-tapered spectral estimates based upon the input data, as at 830. The second multi-tapered spectral estimates may be based upon the transformed data. Different types of the transformed data provide different second multi-tapered spectral estimates. Pairs of the second multi-tapered spectral estimates may be combined to produce first cross-spectra. Pairs of the first multi-tapered spectral estimates and the second multi-tapered spectral estimate may be combined to produce second cross-spectra. The second multi-tapered spectral estimates may be employed in a depth-wise piecemeal fashion.

The method 800 may also include generating second dynamic spectra based upon the second multi-tapered spectral estimates, as at 835. The second dynamic spectra may be generated by applying the second multi-tapered spectral estimates using a third sliding window. The third sliding window may be conducted in depth. The second dynamic spectra may be or include one or more second spectrograms. The second spectrograms may be or include log-log cross-spectrograms and/or log-seismic cross-spectrograms.

The method 800 may also include treating the second dynamic spectra as a second multi-variate sequence in time or depth to produce second treated dynamic spectra, as at 840. Treating the second dynamic spectra may include log transforming the second dynamic spectra to produce second log transformed dynamic spectra, and/or differencing the second log transformed dynamic spectra with local averages thereof to produce the second treated dynamic spectra. The first and/or second dynamic spectra may be employed to detect geo-features. The geo-features may include salt bodies and/or a top of salt.

The method 800 may also include transforming the first and/or second treated dynamic spectra to produce transformed dynamic spectra, as at 845. The first and/or second treated dynamic spectra may be transformed using a log transform and/or a Fourier transform. Transforming emphasizes higher-order dependencies in the first and/or second treated dynamic spectra.

The method 800 may also include determining derivatives of the transformed dynamic spectra, as at 850. The derivatives may be determined based upon time, depth, and/or frequency. The derivatives may be performed directionally.

The method 800 may also include determining dependencies based upon the first and/or second treated dynamic spectra and/or the derivatives, as at 855. The dependencies may be between different frequencies, depth, and/or time. The dependencies may be or include spectral dependencies, instantaneous spectral dependencies, cepstral summaries, cross-coherence, and/or quantities derived therefrom. The dependencies may be used directly to analyze spectral constructs in the input data. The spectral constructs may be employed to modify or replace attention mechanisms in transformer architectures. The spectral constructs may provide better estimator or statistical properties when dealing with sample sizes less than a predetermined threshold. By repeated and/or sequential processing, the spectral constructs may emphasize the higher-order dependencies implicit in the input data.

The method 800 may also include building or updating a deep learning foundation model to employ the dependencies, as at 860. The deep learning foundation model may be built or updated based upon the spectral constructs. The deep learning foundation model may be built or updated using self-learning methodologies. The deep learning foundation model may also be configured to perform downstream seismic and log analysis tasks.

The method 800 may also include modifying neural network formulations based upon the dependencies, as at 865. The neural network formulations may be modified based upon the spectral constructs. Modifying the neural network formulations may include employing the spectral constructs with fixed or trainable parameters.

In another embodiment, modifying the neural network formulations may include modifying the input data using the spectral constructs for further processing by an image transformer or a multi-layer perceptron (MLP)-mixture based model (e.g., Method-A) or a mixture-of-experts (MoE) model.

In another embodiment, modifying the neural network formulations may include modifying query and key constructs in multi-head self-attention (MHSA) units employed in a transformer-based network with a new attention mechanism based upon the spectral constructs. Repeated and/or sequential processing by the MHSA units may compute and provide emphasis on the higher-order dependencies implicit in the input data. The spectral constructs may provide attention on amplitude, phase, and/or frequency modulations. The spectral constructs may provide estimates with better estimator or statistical properties when dealing with small-sample sizes which arise when a feature set is split across a plurality of heads within the MHSA units. The spectral constructs may be deployed after padding a divided feature vector to a fixed size to ensure frequency fidelity across the MHSA units employing varying numbers of the heads (e.g., Method B).

In another embodiment, modifying the neural network formulations may include modifying the MLP-mixture based model to process end-to-end computations using complex numbers. The spectral constructs may be employed before or within modules of the MLP-mixture based model. Linear and/or fully-connected layers of the MLP-mixture based model may be replaced by equivalent units to permit processing of the complex numbers. The modified MLP-mixture based model permits end-to-end processing of the complex numbers to encourage synergistic concurrent processing of amplitude, phase, and/or frequency content at any stage in the MLP-mixture based model (e.g., Method C).

In another embodiment, modifying the neural network formulations may include employing the spectral constructs in network submodules in a mixture-of-experts (MoE) neural network architecture that includes a plurality of experts. Each expert sequentially nests the spectral constructs to a fixed level. Each expert sequentially nests the spectral constructs to varying degrees to indirectly allow simultaneous emphasis of numerous but different higher-order moments implicit within the input data. The spectral constructs are employed to influence a gating unit which weights the experts.

The method 800 may also include identifying features in the input data using the deep learning foundation model, as at 870. The features identified by the deep learning foundation model may emphasize higher-order dependencies in the input data due to an influence of the spectral constructs. The spectral constructs may steer the deep learning foundation model to indirectly identify the features emphasizing higher-order statistical moments within the input data. The spectral constructs may control the nature of the features. The features may be or include seismic features. The seismic features may include or emphasize top of salt, faults, structural and stratigraphic traps, and direct carbon indicators. The direct carbon indicators may be or include bright spots, flat spots, dim spots, and shadow effects.

The method 800 may also include conducting a semantic similarity search for geo-features in seismic or well log collections based upon the features, as at 875. The semantic similarity search may be conducted against known and/or exemplary instances of the seismic or well log geofeatures.

The method 800 may also include displaying an output of the deep learning foundation model, the features, and/or the geo-features, as at 880.

The method 800 may also include performing an action in response to the output of the deep learning foundation model, the features, and/or the geo-features, as at 885. The action may be or include generating and/or transmitting a signal that recommends, instructs, or causes a physical action to occur at a wellsite. The physical action may be or include selecting where to drill a wellbore, drilling the wellbore, varying a weight and/or torque on a drill bit that is drilling the wellbore, varying a drilling trajectory of the wellbore (e.g., to steer toward or away from the features and/or geo-features), or varying a concentration and/or flow rate of a fluid pumped into the wellbore.

Direct estimation of higher-order correlations calculated in the time-domain (e.g., pre-stack, CDP, etc.) and depth-domain (e.g., post-stack) is simply impractical and unreliable. An approach which provides a route out of this dilemma is to treat a spectrogram as a multivariate sequence (e.g., frequency, time/depth) and seek correlations between spectral powers at different frequencies. One observation is that second-order correlations in spectrograms correspond to non-trivial higher-order correlations in the time-/depth-domain. Thus, deriving measures using spectrograms (e.g., dynamic spectra), the higher-order correlations may be captured in the original domain.

The methodology may also be employed to quickly identify specific aspects of seismic data, effectively providing an unsupervised means of generating labels to be used for supervised or semi-supervised machine learning development. ML models trained in such a fashion, and generalized sufficiently, can be applied to other seismic surveys.

For the various seismic features noted above, the proposed methodology would provide a reliable means to detect and characterize them. In some instances, there is “no existing technology” and where they do exist, the approach would be a more direct means to robustly evaluate them.

### Exemplary Computing System

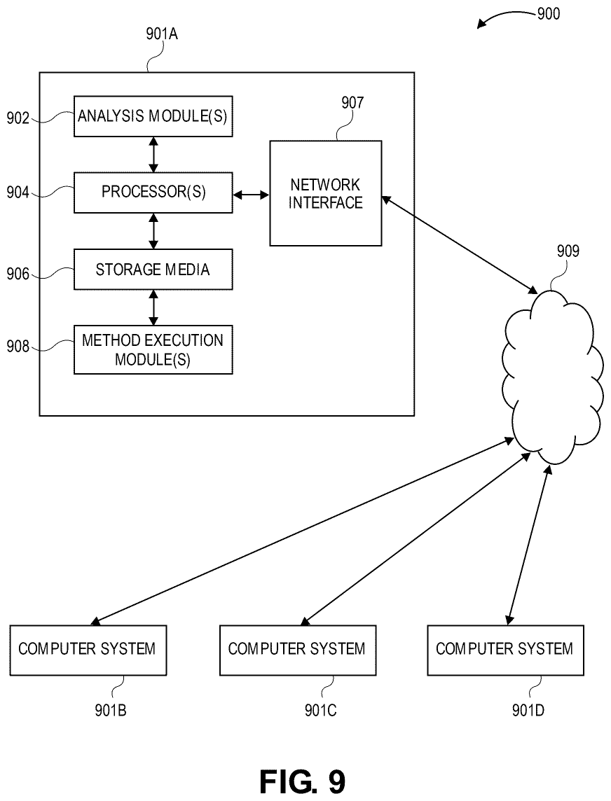

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 900 contains one or more spectral approach module(s) 908. In the example of computing system 900, computer system 901A includes the spectral approach module 908. In some embodiments, a single spectral approach module may be used to perform some aspects of one or more embodiments of the methods disclosed herein. In other embodiments, a plurality of spectral approach modules may be used to perform some aspects of methods herein.

It should be appreciated that computing system 900 is merely one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for estimating higher-order dependencies from input data, the method comprising:
receiving input data;
generating first multi-tapered spectral estimates based upon input data;
determining dependencies based at least partially upon the first multi-tapered spectral estimates; and
building or updating a deep learning foundation model to employ the dependencies.

2. The method of claim 1, wherein the input data comprises seismic data and/or well log data.

3. The method of claim 1, further comprising transforming the input data into a frequency domain to produce transformed data, wherein the transformed data comprises transformed seismic data and transformed well log data, and wherein the first multi-tapered spectral estimates are generated based upon the transformed data.

4. The method of claim 1, further comprising:
generating first dynamic spectra by applying the first multi-tapered spectral estimates using a sliding window; and
treating the first dynamic spectra as a first multi-variate sequence in time or depth to produce first treated dynamic spectra, wherein the dependencies are determined based at least partially upon the first treated dynamic spectra.

5. The method of claim 4, further comprising:
generating second multi-tapered spectral estimates based upon the input data, wherein the first multi-tapered spectral estimates are based upon seismic data in the input data, and wherein the second multi-tapered spectral estimates are based upon well log data in the input data;
generating second dynamic spectra based upon the second multi-tapered spectral estimates; and
treating the second dynamic spectra as a second multi-variate sequence in time or depth to produce second treated dynamic spectra, wherein the dependencies are also determined based at least partially upon the second treated dynamic spectra.

6. The method of claim 4, further comprising:
transforming the first treated dynamic spectra to produce transformed dynamic spectra; and
determining derivatives of the transformed dynamic spectra, wherein the dependencies are determined based at least partially upon the derivatives.

7. The method of claim 1, wherein the dependencies are between different frequencies, depth, and/or time, wherein the dependencies comprise spectral dependencies, instantaneous spectral dependencies, cepstral summaries, cross-coherence, and/or quantities derived therefrom, and wherein the dependencies are used directly to analyze spectral constructs in the input data.

8. The method of claim 7, wherein the deep learning foundation model is built or updated based upon the spectral constructs.

9. The method of claim 1, further comprising displaying an output of the deep learning foundation model.

10. The method of claim 1, further comprising performing an action in response to an output of the deep learning foundation model, wherein the action comprises drilling a wellbore, varying a weight and/or torque on a drill bit that is drilling the wellbore, varying a drilling trajectory of the wellbore, or varying a concentration and/or flow rate of a fluid pumped into the wellbore.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises seismic data and well log data;
transforming the input data into a frequency domain to produce transformed data, wherein the transformed data comprises transformed seismic data and transformed well log data;
generating multi-tapered spectral estimates based upon transformed data;
generating dynamic spectra by applying the multi-tapered spectral estimates using a first sliding window;
treating the dynamic spectra as a multi-variate sequence in time or depth to produce treated dynamic spectra;
transforming the treated dynamic spectra to produce transformed dynamic spectra, wherein transforming emphasizes higher-order dependencies in the treated dynamic spectra;
determining derivatives of the transformed dynamic spectra;
determining dependencies based upon the treated dynamic spectra and/or the derivatives, wherein the dependencies are used directly to analyze spectral constructs in the input data; and
building or updating a deep learning foundation model to employ the dependencies, wherein the deep learning foundation model is built or updated based upon the spectral constructs.

12. The computing system of claim 11, wherein transforming the input data comprises:
tapering the seismic data using a multi-taper spectral approach to produce tapered data, wherein the multi-taper spectral approach employs a plurality of discrete prolate spheroidal sequences as tapers; and
transforming the tapered data using a Fourier transform to produce the transformed data, wherein the transformed data is also produced from the input data using a third sliding window.

13. The computing system of claim 11, wherein treating the dynamic spectra comprises:
log transforming the dynamic spectra to produce log transformed dynamic spectra; and/or
differencing the log transformed dynamic spectra with local averages thereof to produce the treated dynamic spectra.

14. The computing system of claim 11, wherein the operations further comprise identifying features in the input data using the deep learning foundation model, wherein the spectral constructs steer the deep learning foundation model to indirectly identify the features emphasizing higher-order statistical moments within the input data, wherein the features comprise seismic features, wherein the seismic features emphasize top of salt, faults, structural and stratigraphic traps, and/or direct carbon indicators.

15. The computing system of claim 14, wherein the operations further comprise conducting a semantic similarity search for geo-features in seismic or well log collections based upon the features, wherein the semantic similarity search is conducted against known and/or exemplary instances of the seismic or well log geofeatures.

16. A non-transitory computer-readable medium storing instructions that, when executed by one or more processors of a computing system, cause the computing system to perform operations, the operations comprising:
receiving input data, wherein the input data comprises seismic data and well log data, wherein the seismic data is captured from a gather space, a pre-stack space, or a post-stack space;
transforming the input data into a frequency domain to produce transformed data, wherein the transformed data comprises transformed seismic data and transformed well log data, and wherein transforming the input data comprises:
tapering the seismic data using a multi-taper spectral approach to produce tapered data, wherein the multi-taper spectral approach employs a plurality of discrete prolate spheroidal sequences as tapers; and
transforming the tapered data using a Fourier transform to produce the transformed data, wherein the transformed data is also produced from the input data using a first sliding window;
generating first multi-tapered spectral estimates based upon transformed data, wherein the first multi-tapered spectral estimates are based upon the transformed seismic data, wherein the first multi-tapered spectral estimates are generated based upon a magnitude square of the transformed seismic data and averaged over the tapered data, and wherein the first multi-tapered spectral estimates comprise power spectra and cross-spectra;
generating first dynamic spectra by applying the first multi-tapered spectral estimates using a second sliding window, wherein the second sliding window is conducted in time, depth, or spatially, and wherein the first dynamic spectra comprise first spectrograms;
treating the first dynamic spectra as a first multi-variate sequence in time or depth to produce first treated dynamic spectra, wherein treating the first dynamic spectra comprises:
log transforming the first dynamic spectra to produce first log transformed dynamic spectra; and/or
differencing the first log transformed dynamic spectra with local averages thereof to produce the first treated dynamic spectra;
generating second multi-tapered spectral estimates based upon the input data, wherein the second multi-tapered spectral estimates are based upon the transformed data, wherein different types of the transformed data provide different second multi-tapered spectral estimates, wherein pairs of the second multi-tapered spectral estimates are combined to produce first cross-spectra, wherein pairs of the first multi-tapered spectral estimates and the second multi-tapered spectral estimate are combined to produce second cross-spectra, and wherein the second multi-tapered spectral estimates are employed in a depth-wise piecemeal fashion;
generating second dynamic spectra based upon the second multi-tapered spectral estimates, wherein the second dynamic spectra are generated by applying the second multi-tapered spectral estimates using a third sliding window, wherein the third sliding window is conducted in depth, wherein the second dynamic spectra comprise second spectrograms, and wherein the second spectrograms comprise log-log cross-spectrograms and/or log-seismic cross-spectrograms;
treating the second dynamic spectra as a second multi-variate sequence in time or depth to produce second treated dynamic spectra, wherein treating the second dynamic spectra comprises:
log transforming the second dynamic spectra to produce second log transformed dynamic spectra; and/or
differencing the second log transformed dynamic spectra with local averages thereof to produce the second treated dynamic spectra, wherein the first and/or second dynamic spectra are employed to detect geo-features, and wherein the geo-features comprise salt bodies and/or a top of salt;
transforming the first and second treated dynamic spectra to produce transformed dynamic spectra, wherein the first and second treated dynamic spectra are transformed using a log transform and a Fourier transform, and wherein transforming emphasizes higher-order dependencies in the first and/or second treated dynamic spectra;
determining derivatives of the transformed dynamic spectra, wherein the derivatives are determined based upon time, depth, and/or frequency, and wherein the derivatives are performed directionally;
determining dependencies based upon the first and second treated dynamic spectra and the derivatives, wherein the dependencies are between different frequencies, depth, and/or time, wherein the dependencies comprise spectral dependencies, instantaneous spectral dependencies, cepstral summaries, cross-coherence, and/or quantities derived therefrom, wherein the dependencies are used directly to analyze spectral constructs in the input data, wherein the spectral constructs are employed to modify or replace attention mechanisms in transformer architectures, wherein the spectral constructs provide better estimator or statistical properties when dealing with sample sizes less than a predetermined threshold, and wherein by repeated and/or sequential processing, the spectral constructs emphasize the higher-order dependencies implicit in the input data;
building or updating a deep learning foundation model to employ the dependencies, wherein the deep learning foundation model is built or updated based upon the spectral constructs, wherein the deep learning foundation model is built or updated using self-learning methodologies, and wherein the deep learning foundation model is also configured to perform downstream seismic and log analysis tasks; and
identifying features in the input data using the deep learning foundation model, wherein the spectral constructs steer the deep learning foundation model to indirectly identify the features emphasizing higher-order statistical moments within the input data, wherein the spectral constructs control a nature of the features, wherein the features identified by the deep learning foundation model emphasize higher-order dependencies in the input data due to an influence of the spectral constructs, wherein the features comprise seismic features, wherein the seismic features emphasize top of salt, faults, structural and stratigraphic traps, and/or direct carbon indicators, and wherein the direct carbon indicators comprise bright spots, flat spots, dim spots, and/or shadow effects.

17. The non-transitory computer-readable medium of claim 16, wherein the operations further comprise modifying neural network formulations based upon the dependencies, wherein the neural network formulations are modified based upon the spectral constructs, and wherein modifying the neural network formulations comprises modifying the input data using the spectral constructs for further processing by an image transformer or a multi-layer perceptron (MLP)-mixture based model.

18. The non-transitory computer-readable medium of claim 16, wherein the operations further comprise modifying neural network formulations based upon the dependencies, wherein the neural network formulations are modified based upon the spectral constructs, and wherein modifying the neural network formulations comprises modifying query and key constructs in multi-head self-attention (MHSA) units employed in a transformer-based network with a new attention mechanism based upon the spectral constructs, wherein repeated and sequential processing by the MHSA units computes and provides emphasis on the higher-order dependencies implicit in the input data, wherein the spectral constructs provide attention on amplitude, phase, and/or frequency modulations, wherein the spectral constructs provide estimates with better estimator or statistical properties when dealing with small-sample sizes which arise when a feature set is split across a plurality of heads within the MHSA units, wherein the spectral constructs are deployed after padding a divided feature vector to a fixed size to ensure frequency fidelity across the MHSA units employing varying numbers of the heads.

19. The non-transitory computer-readable medium of claim 16, wherein the operations further comprise modifying neural network formulations based upon the dependencies, wherein the neural network formulations are modified based upon the spectral constructs, and wherein modifying the neural network formulations comprises modifying a multi-layer perceptron (MLP)-mixture based model to process end-to-end computations using complex numbers, wherein the spectral constructs are employed before or within modules of the MLP-mixture based model, wherein linear and/or fully-connected layers of the MLP-mixture based model are replaced by equivalent units to permit processing of the complex numbers, wherein the modified MLP-mixture based model permits end-to-end processing of the complex numbers to encourage synergistic concurrent processing of amplitude, phase, and/or frequency content at any stage in the MLP-mixture based model.

20. The non-transitory computer-readable medium of claim 16, wherein the operations further comprise modifying neural network formulations based upon the dependencies, wherein the neural network formulations are modified based upon the spectral constructs, and wherein modifying the neural network formulations comprises employing the spectral constructs in network submodules in a mixture-of-experts (MoE) neural network architecture that includes a plurality of experts, wherein each expert sequentially nests the spectral constructs to a fixed level, wherein each expert sequentially nests the spectral constructs to varying degrees to indirectly allow simultaneous emphasis of numerous but different higher-order moments implicit within the input data, and wherein the spectral constructs are employed to influence a gating unit which weights the experts.
